(19) United States
(12) Patent Application Publication
(10) Pub. No.: US 2011/0225566 A1
(43) Pub. Date: Sep. 15, 2011

(54) TESTING USER INTERFACES IN MULTIPLE EXECUTION ENVIRONMENTS

(75) Inventors: Joe Allan Muharsky, Duvall, WA (US); Ryan Vogrinec, Redmond, WA (US); Brandon Scott Wadsworth, Woodinville, WA (US)

(73) Assignee: Microsoft Corporation, Redmond, WA (US)

(21) Appl. No.: 12/720,691

(22) Filed: Mar. 10, 2010

(51) Int. Cl. G06F 9/44

(52) U.S. Cl. 717/124

(57) ABSTRACT

Methods, systems, and computer-readable media to test user interfaces (UIs) in multiple execution environments are disclosed. A particular method includes selecting one or more UI tests and one or more execution environments in which to run the UI tests. One of the execution environments is designated as a driver execution environment. A driver UI corresponding to the driver execution environment is displayed. When a UI action is received at the driver UI, a data representation of the UI action is transmitted from the driver execution environment to each of the other execution environments. The UI action is substantially concurrently repeated at each of the other execution environments.

### BACKGROUND

Software vendors often release a software application on multiple computing platforms. Prior to release, the software application is typically tested on each of the computing platforms. Iterative testing of software at multiple platforms may be time-consuming. For example, each test iteration for a particular platform may incur time and resource overhead due to repeated reconfiguration of the application for each test iteration.

### SUMMARY

A method to test user interfaces (UIs) in multiple execution environments is disclosed. UI actions performed at one execution environment (e.g., a “driver” execution environment) may be automatically and substantially concurrently repeated at one or more other execution environments. A user (e.g., a UI tester) may be provided with a heads-up display (HUD) that includes UIs generated by each execution environment and that identifies differences in state or appearance between the execution environments.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a diagram to illustrate a particular embodiment of a system to test user interfaces in multiple execution environments;

FIG. 2 is a diagram to illustrate another particular embodiment of a system to test user interfaces in multiple execution environments;

FIG. 3 is a data flow diagram to illustrate a particular embodiment of data flow at the system of FIG. 1 or the system of FIG. 2;

FIG. 4 is a flow diagram to illustrate a particular embodiment of a method of testing user interfaces in multiple execution environments;

FIG. 5 is a screenshot of a particular embodiment of a heads-up display (HUD) to display a driver execution environment and other execution environments; and

FIG. 6 is a block diagram of a computing environment including a computing device operable to support embodiments of computer-implemented methods, computer program products, and system components as illustrated in FIGS. 1-5.

### DETAILED DESCRIPTION

In a particular embodiment, a computer-implemented method includes selecting one or more tests associated with a user interface (UI)-based application and selecting a plurality of execution environments. One of the plurality of execution environments is designated a driver execution environment. The method also includes displaying a driver UI corresponding to the driver execution environment. The method further includes receiving a UI action associated with the one or more tests at the driver UI. The method includes transmitting a representation of the UI action from the driver execution environment to each of the other execution environments. The UI action is substantially concurrently repeated at each of the other execution environments. In an alternate embodiment, ad hoc testing may be performed at the driver execution environment and may be replicated at the other execution environments.

In another particular embodiment, a computer system includes a memory and a processor coupled to the memory. The processor is configured to execute instructions that cause execution of a user interface (UI) testing application that includes a heads-up display (HUD) and a communications bus. The HUD is configured to display each of a plurality of execution environments, where one of the plurality of execution environments is designated as a driver execution environment. The HUD is also configured to receive a UI action associated with a UI test at the driver execution environment. The HUD is further configured to transmit a representation of the UI action from the driver environment to each of the other execution environments. The UI action is substantially concurrently repeated at each of the other execution environments. The communications bus is coupled to each of the plurality of execution environments and is configured to broadcast data from the driver execution environment to each of the other execution environments.

In another particular embodiment, a computer-readable medium includes instructions, that when executed by a computer, cause the computer to select one or more tests associated with a user interface (UI)-based application and to select a plurality of execution environments. One of the plurality of execution environments is designated as a driver execution environment. The instructions also cause the computer to initialize a communication agent at each of the plurality of execution environments and to display a driver UI corresponding to the driver execution environment. The instructions further cause the computer to receive a UI action associated with the one or more tests at the driver UI. The instructions cause the computer to transmit a representation of the UI action from the communication agent at the driver execution environment to the communication agent at each of the other execution environments via a communications bus. The UI action is substantially concurrently repeated at each of the other execution environments.

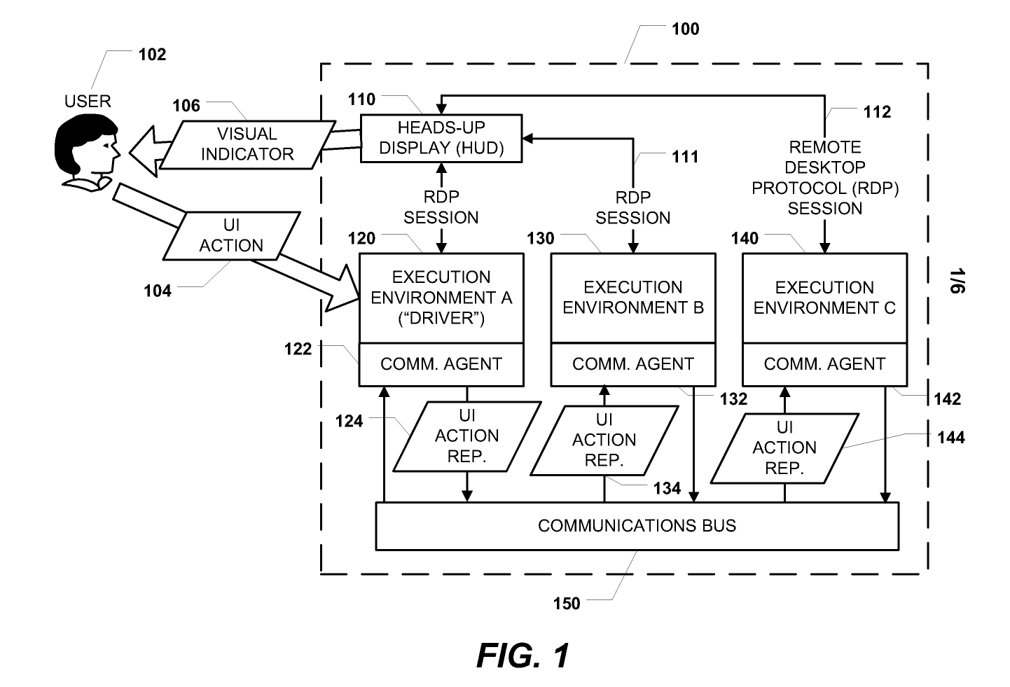

FIG. 1 depicts a particular embodiment of a system 100 to test user interfaces (UIs) in multiple execution environments. The system 100 includes a heads-up display (HUD) 110 and a communications bus 150. The system also includes a plurality of execution environments (e.g., illustrative execution environments 120, 130, and 140). One of the execution environments is designated as a driver execution environment. For example, in the particular embodiment illustrated in FIG. 1, the “Execution Environment A” is designated as a driver execution environment 120. In a particular embodiment, the system 100 is implemented by a computing device. Generally, the system 100 of FIG. 1 may be operable to substantially concurrently test UIs at each of the execution environments 120, 130, and 140. For example, the UI testing may be ad hoc testing or may be based on pre-defined test cases and scenarios.

The driver execution environment 120 may be configured to receive a UI action 104 from a user 102 during concurrent UI testing of the execution environments 120, 130, and 140. The driver execution environment 120 (or a testing application executing at the driver execution environment 120) may translate the UI action 104 into a UI action representation 124. For example, the UI action representation 124 may include a set of input device controls (e.g., keyboard entries, mouse movements, and mouse clicks, pen controls, touch screen controls, multi-touch controls, or any other input device controls). The input device controls may also include timing parameters (e.g., wait times). The UI action representation 124 may also include automatically generated software code that is executable to repeat the UI action 104. The driver execution environment 120 may transmit the UI action representation 124 (e.g., in a serialized format) to each of the other execution environments 130, 140. In a particular embodiment, the UI action representation 124 is broadcast by a communication agent 122 of the driver execution environment 120 to communication agents 132, 142 of the other execution environments 130, 140 via a communications bus 150.

Each of the other execution environments 130 and 140 may receive the UI action representations 134, 144 and may substantially concurrently repeat the UI action 104 based on the UI action representations 134, 144. Thus, the UI action 104 (e.g., a UI action associated with a UI test) may be performed at one execution environment and may be substantially concurrently repeated at multiple other execution environments. It should be noted that the UI action representations 124, 134, and 144 may be identical and the UI action representations 124, 134, and 1444 may be machine and execution environment independent. Thus, UI action representations may be transmitted to multiple execution environments without performing individualized formatting or configuration of the UI action representations.

The HUD 110 may display each of the execution environments 120, 130, and 140. For example, the HUD 110 may display the execution environments 120, 130, and 140 to the user 102 via a display device. In a particular embodiment, the HUD 110 may display one or more execution environments via a remote desktop protocol (RDP) session. For example, the HUD 110 may display the non-driver execution environments 130 and 140 via RDP sessions 111 and 112 with the non-driver execution environments 130 and 140, respectively. In a particular embodiment, the HUD may also display the driver execution environment 120 via an RDP session.

In a particular embodiment, the HUD 110 is also configured to receive a designation from the user 102 of a new driver execution environment. The HUD 110 may also be configured to provide visual indicators (e.g., an illustrative visual indicator 106) of UI test results to the user 102. For example, the visual indicator 106 may indicate that after the UI action 104 has been performed at each of the execution environments 120, 130, and 140, a first execution environment has a different state than a second execution environment. The state may include one or more of a UI screenshot, a navigational state, a modal state, an automation state, a parametric state, and performance metrics (e.g., an amount of memory and processor time consumed during performance of the UI action). Comparing the state between two execution environments may include a bit by bit comparison of images, a comparison of images with resolution differences projected, an adjustment of images for other accessibility requirements (e.g., color blindness, etc), a comparison of strings in different languages (e.g., when a primary test operator (e.g., the user 102) only speaks English, the comparison may include translations to enable the English speaker to effectively test other languages), a comparison of different display mediums (e.g., desktop-sized vs. mobile device-sized) including compensating for screen resolution differences, and other comparisons.

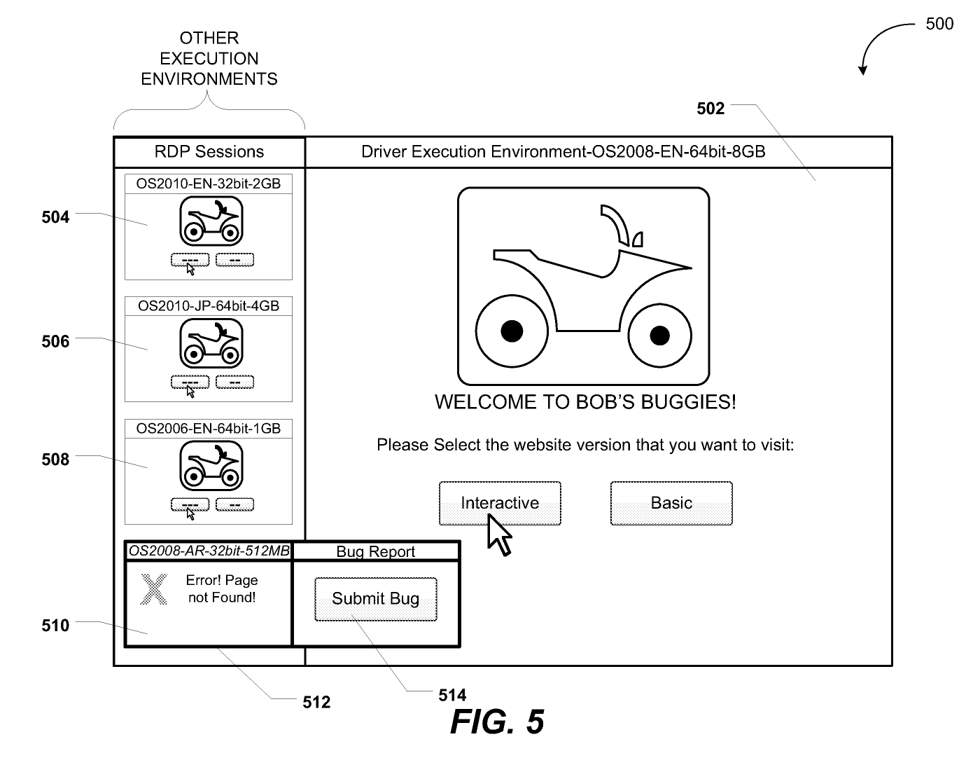

The HUD 110 may compare and detect mismatches in the states of the various execution environments 120, 130, and 140. HUDs are further described and illustrated with reference to FIG. 5. The user 102 may take actions (e.g., bug-reporting) based on the visual indicator 106. For example, to get a divergent (e.g., mismatched) execution environment in line with the other execution environments, the user 102 may designate a new driver execution environment, disable UI action replication at the system 100, and make UI actions at the divergent execution environment as needed.

In a particular embodiment, when a system includes multiple execution environments, one or more of the execution environments may be implemented by a virtual machine. For example, the driver execution environment 120 may be a native (e.g., “host”) execution environment of the system 100 and the other execution environments 130, 140 may be executed (e.g., as “guest” environments) by virtual machines at the system 100.

In operation, one or more tests for a UI-based application may be selected for execution at each of a plurality of selected execution environments (e.g., the execution environments 120, 130, and 140). The execution environments 120, 130, and 140 may differ from each other with respect to display resolution, text language (e.g., English vs. Spanish), software application (e.g., different web browsers or different versions of the same web browser), operating system, hardware architecture (e.g., 32-bit vs. 64-bit), machine condition (e.g., a “fresh” machine vs. a machine with “evolved state”), with respect to other characteristics, or some combination thereof. It should be noted that such differences are for illustration purposes only and not to be deemed limiting. The HUD 110 may display the driver execution environment 120 to the user 102 and the driver execution environment 120 may receive the UI action 104 from the user. For example, the UI action 104 may be a button push at a web browser via a mouse click. The driver execution environment 120 may generate a UI action representation 124 based on the UI action 104 and may transmit the UI action representation 124 to the other execution environments 130 and 140.

The other execution environments 130 and 140 may substantially concurrently repeat the UI action 104. For example, the other execution environments 130 and 140 may substantially concurrently perform the web browser button push. The HUD 110 may display the various execution environments 120, 130, 140. The HUD 110 may also display a visual indicator 106 upon detecting a state mismatch between two of the execution environments 120, 130, 140. For example, the visual indictor 106 may indicate that following the web browser button push, the third execution environment 140 has a different UI state than the driver execution environment 120 and the second execution environment 130, thereby indicating a possible bug in the web browser at the third execution environment 140.

The testing process may be repeated for each UI action 104 received at the system 100. For example, a second UI action may be received at the driver execution environment 120 and a representation of the second UI action may be transmitted from the driver execution environment to each of the other execution environments 130 and 140.

It will be appreciated that the system 100 of FIG. 1 may enable substantially concurrent UI testing in multiple execution environments without incurring overhead due to reconfiguration or task-switching. It will thus be appreciated that the system 100 of FIG. 1 may reduce an overall testing time for a UI-based application that is compatible with multiple execution environments.

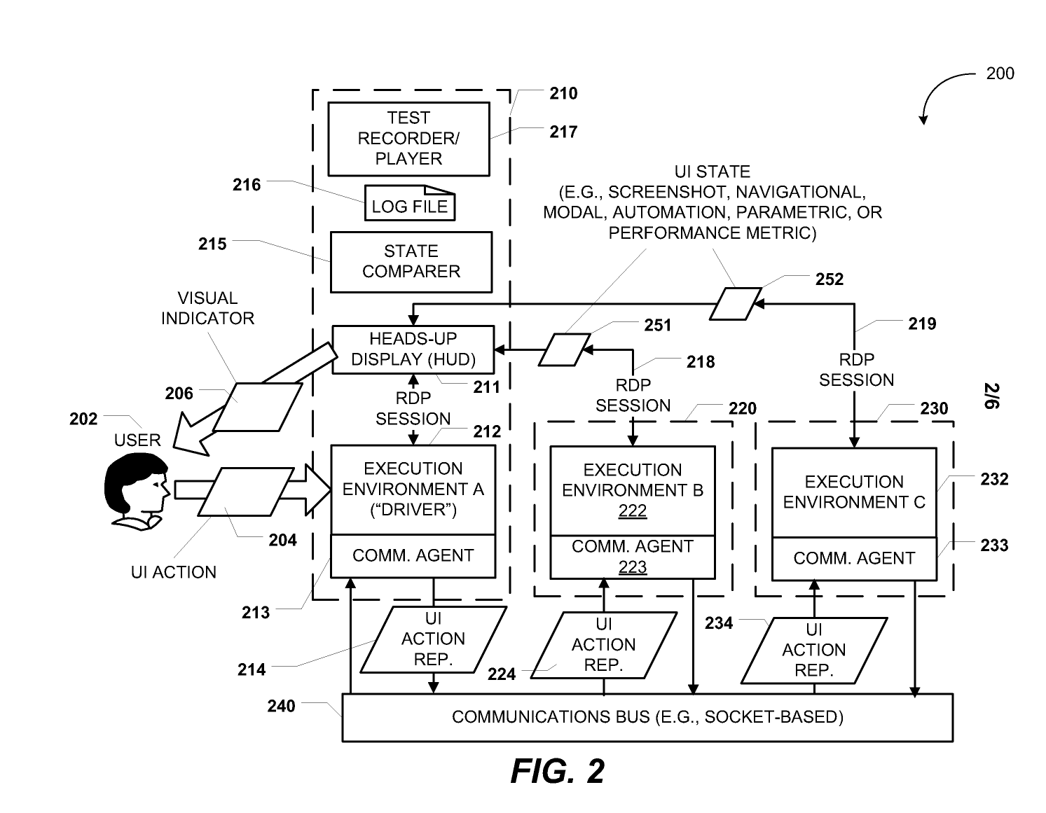

FIG. 2 depicts another particular embodiment of a system 200 to test user interfaces in multiple execution environments. The system 200 includes a plurality of computing devices (e.g., illustrative computing devices 210, 220, and 230). Each computing device may include one or more execution environments. For example, the first computing device 210 may include a first execution environment 212, the second computing device 220 may include a second execution environment 222, and the third computing device 230 may include a third execution environment 232. One of the execution environments is designated a driver execution environment. For example, in the particular embodiment illustrated in FIG. 2, “Execution Environment A” is designated as a driver execution environment 212.

The driver execution environment 212 may be configured to receive a UI action 204 from a user 202 during UI testing of the execution environments 212, 222, and 232. The driver execution environment 212 may translate the UI action 214 into a UI action representation 214 and may transmit the UI action representation 214 to each of the other execution environments 222, 232. In a particular embodiment, the UI action representation 214 is broadcast by a communication agent 213 of the driver execution environment 212 to communication agents 223, 233 of the other execution environments 222, 232 via a communications bus 240. For example, the communications bus may be implemented using socket-based communication between the computing devices 210, 220, and 230. Alternately, the communications bus 240 may be implemented by some other inter-computing device communications protocol.

Each of the other execution environments 222 and 232 may receive UI action representations 224 and 234 and may substantially concurrently repeat the UI action 204 based on the UI action representations 224 and 234.

A HUD 211 may display each of the execution environments 212, 222, and 232. For example, the HUD 211 may display the execution environments 212, 222, and 232 to the user 202 via a display device. In a particular embodiment, the HUD 211 displays one or more execution environments via a remote desktop protocol (RDP) session. For example, the HUD 211 may display the non-driver execution environments 222 and 232 via RDP sessions 218 and 219 with the non-driver execution environments 222 and 232, respectively.

The HUD 211 may also receive UI states from execution environments. For example, the HUD 211 may receive UI states 251 and 252 from the non-driver execution environments 222 and 232, respectively, after the UI action 204 has been repeated at the non-driver execution environments 222 and 232. The UI states 251, 252 may each include one or more of a UI screenshot, a navigational state, a modal state, an automation state, a parametric state, and performance metrics. HUDs are further described and illustrated with reference to FIG. 5.

In a particular embodiment, the first computing device 210 includes a state comparer 215 that is configured to compare UI states. For example, the state comparer 215 may compare the UI states 251 and 252 with a UI state of the driver execution environment 212. The state comparer 215 may also be configured to determine when a state mismatch exists between UI states. In a particular embodiment, when a state mismatch exists, the mismatch may be noted in a log file 216. For example, an entry may be created at the log file 216, where the log file 216 is part of a UI bug-reporting application. The HUD 211 may also provide a visual indicator 206 of the state mismatch to the user 202.

In a particular embodiment, the first computing device 210 also includes a test recorder and player 217. The test recorder and player 217 may record multiple UI actions and store representations of the multiple UI actions, including timing information (e.g., wait times) associated with the multiple UI actions. The stored representations may be transmittable to execution environments via the communications bus 240. The test recorder and player 217 may also be configured to reproduce UI actions based on stored representations of the UI actions. Thus, when each of the computing devices 210, 220, and 230 includes a test recorder and player, UI actions may be transmitted and repeated in batches instead of one-at-a-time. For example, a UI test suite may be recorded at one execution environment and then substantially concurrently reproduced at multiple execution environments.

In operation, the UI action 204 (e.g., a UI action associated with a UI test) may be received at the driver execution environment 212 and may be substantially concurrently repeated at the other execution environments 222, 232. The HUD 211 may display the execution environments 212, 222, 232 and the state comparer 215 may determine whether the UI action 204 resulted in a state mismatch between the execution environments 212, 222, 232. When a state mismatch is detected, the HUD 211 may provide the visual indicator 206 to the user 202.

It will be appreciated that the system 200 of FIG. 2 may enable substantially concurrent UI testing at multiple computing devices, (e.g., at a distributed computing system).

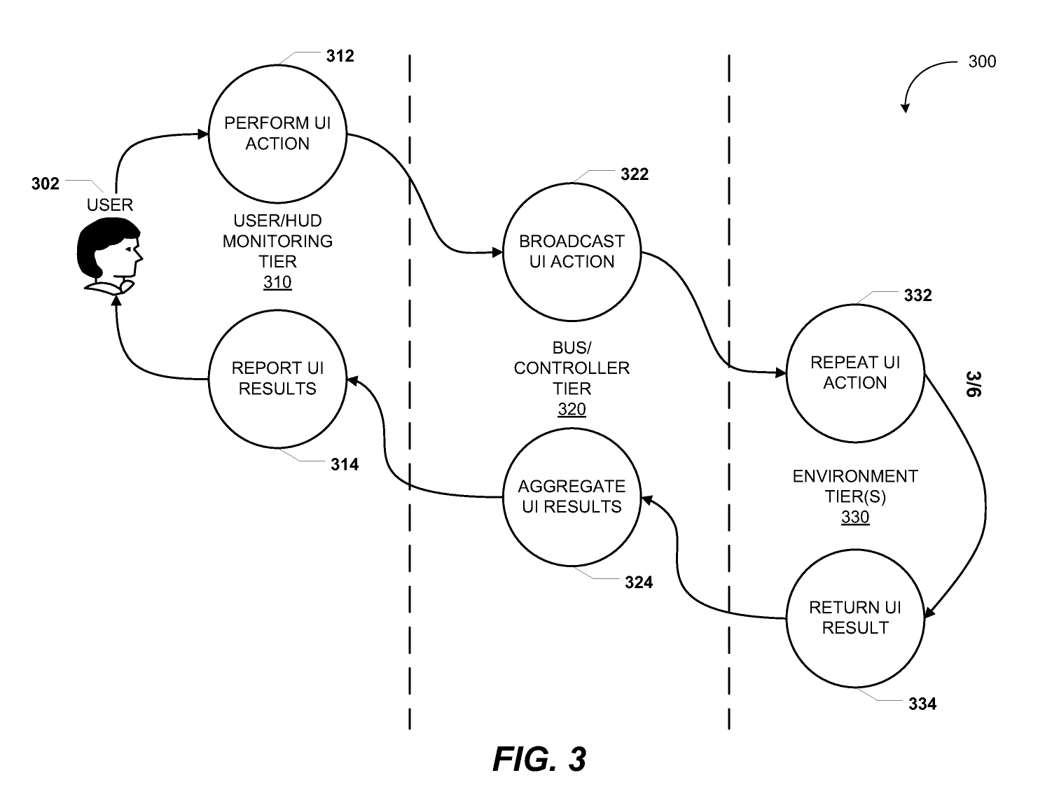

FIG. 3 depicts a data flow diagram 300 to illustrate a particular embodiment of data flow at the system 100 of FIG. 1 or the system 200 of FIG. 2.

Data flow at a UI testing system may be divided into multiple tiers. For example, a user/HUD monitoring tier 310 and a bus/controller tier 320 may be associated with a driver execution environment. In addition, one or more environment tiers 330 may be associated with one or more non-driver execution environments. In an illustrative embodiment, the user/HUD monitoring tier 310 and the bus/controller tier 320 may be associated with the driver execution environment 120 of FIG. 1, and the environment tiers 330 may be associated with each of the non-driver execution environments 130 and 140. In another illustrative embodiment, the user/HUD monitoring tier 310 and the bus/controller tier 320 may be associated with the driver execution environment 212 of FIG. 2, and the environment tiers 330 may be associated with each of the non-driver execution environments 222 and 232 of FIG. 1.

Data flow may begin at the user/HUD monitoring tier 310 when a user 302 performs 312 a UI action. Proceeding to the bus/controller tier 320, the UI action (or a representation thereof) may be broadcast 322 to all non-driver execution environments. Next, each of the environment tiers 330 at the non-driver execution environments may repeat 332 the UI action (e.g., in substantially concurrent fashion). A UI result may then be returned 334 from each of the environment tiers 330 to the bus/controller tier 320. The UI results may be aggregated 324 at the bus/controller tier 320 and may be reported 314 to the user 302 by the user/HUD monitoring tier 310. Data flow may continue between the tiers 310, 320, and 330 in cyclical fashion until all the UI tests have been completed.

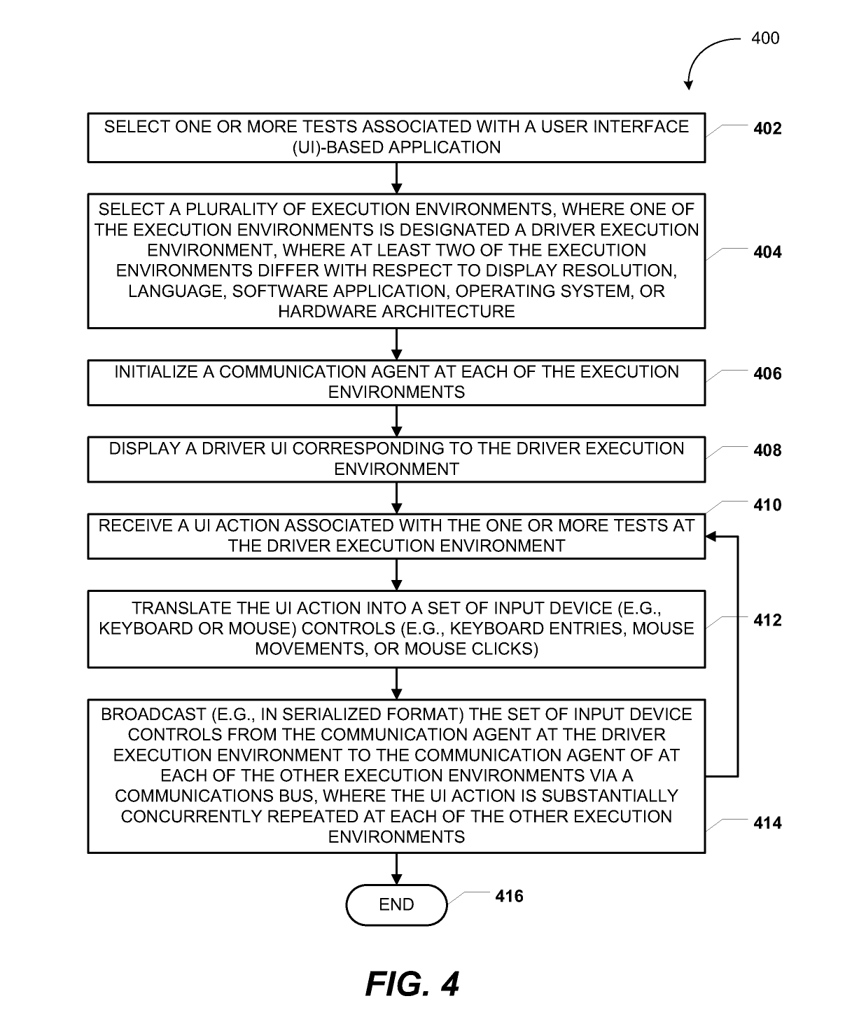

FIG. 4 depicts a flow diagram to illustrate a particular embodiment of a method 400 of testing user interfaces in multiple execution environments. In an illustrative embodiment, the method 400 may be performed by the system 100 of FIG. 1 or the system 200 of FIG. 2.

The method 400 includes selecting one or more tests associated with a user interface (UI)-based application, at 402, and selecting a plurality of execution environments, at 404. One of the execution environments is designated a driver execution environment and at least two of the execution environments differ with respect to display resolution, language, software application, operating system, hardware architecture, drivers, versions, other environmental variances, or some other characteristic. For example, referring to FIG. 1, one or more UI tests may be selected for execution at the execution environments 120, 130, and 140, where “Execution Environment A” is the driver execution environment 120.

The method 400 also includes initializing a communication agent at each of the execution environments, at 406. For example, referring to FIG. 1, the communication agents 122, 132, and 142 may be initialized (e.g., a host application that includes the communication agents may be activated at each of the execution environments 120, 130, and 140). The method 400 further includes displaying a driver UI corresponding to the driver execution environment, at 408. For example, referring to FIG. 1, the HUD 110 may display the driver execution environment 120.

The method 400 includes receiving a UI action associated with the one or more tests at the driver execution environment, at 410. For example, referring to FIG. 1, the UI action 104 may be received at the driver execution environment 120. The method 400 also includes translating the UI action into a set of input device controls, at 412. The input device may be a keyboard or a mouse and the input device controls may be keyboard entries, mouse movements, or mouse clicks. For example, referring to FIG. 1, the UI action 104 may be translated into the UI action representation 124, where the UI action representation 124 includes input device controls.

The method 400 further includes broadcasting the set of input device controls from the communication agent at the driver execution environment to the communication agent at each of the other execution environments via a communications bus, at 414. The input device controls may be broadcast in a serialized format. The UI action is substantially concurrently repeated at each of the other execution environments. For example, referring to FIG. 1, the UI action representation 124 may be broadcast from the communication agent 122 to the communication agents 132, 142 via the communications bus 150, and the UI action 104 may be substantially concurrently repeated at the other execution environments 130, 140.

The method 400 may loop back from 414 to 410, for each such UI action associated with the one or more tests. The method ends (e.g., when the one or more tests are complete) at 416.

FIG. 5 is a screenshot of a particular embodiment of a heads-up display (HUD) 500 to display a driver execution environment 502 and other execution environments 504, 506, 508, and 510. In an illustrative embodiment, the HUD 500 may include the HUD 110 of FIG. 1 or the HUD 211 of FIG. 2.

In the particular embodiment illustrated in FIG. 5, the driver execution environment 502 is a 64-bit English language 2008 version operating system environment having 8 GB of RAM. The first non-driver execution environment 504 is a 32-bit English language 2010 version operating system environment having 2 GB of RAM. The second non-driver execution environment 506 is a 64-bit Japanese language 2010 version operating system environment having 4 GB of RAM. The third non-driver execution environment 508 is a 64-bit English language 2006 version operating system environment having 1 GB of RAM. The fourth non-driver execution environment 510 is a 32-bit Arabic language 2008 version operating system environment having 512 MB of RAM.

The driver execution environment 502 may be displayed at the HUD 500. A user may interact with the driver execution environment 502 (e.g., via a keyboard, a mouse, or other input device). When the user performs a particular UI action, the UI action may be substantially concurrently repeated at the other execution environments 504, 506, 508, and 510. The UI states at each of the other execution environments 504, 506, 508, and 510 may be displayed at the HUD 500. In a particular embodiment, the UI states may be displayed via a RDP session with the other execution environments 504, 506, 508, and 510. The other execution environments 504, 506, 508, and 510 may be at the same computing device as the driver execution environment 502 or may be at different computing devices. Furthermore, in a particular embodiment, the HUD 500 may be displayed at a computing device that does not include any of the execution environments 502, 504, 506, 508, and 510.

The HUD 500 may display a visual indicator 512 upon detecting a UI state mismatch. Displaying the visual indicator 512 may include changing the color, font, or border associated with an execution environment. For example, in the particular embodiment illustrated in FIG. 5, an error has occurred at the fourth non-driver execution environment 510. Thus, the fourth non-driver execution environment 510 indicates a state mismatch with the driver execution environment 502. When a state mismatch is detected, the HUD 500 may provide a method to log the state mismatch. For example, the HUD 500 may include a bug submission dialog 514 that is operable to log the state mismatch.

It will be appreciate that the HUD 500 of FIG. 5 may conveniently provide simultaneous display of each execution environment being tested. It will also be appreciated that the HUD 500 of FIG. 5 may automatically provide error-reporting capabilities when a state mismatch is detected.

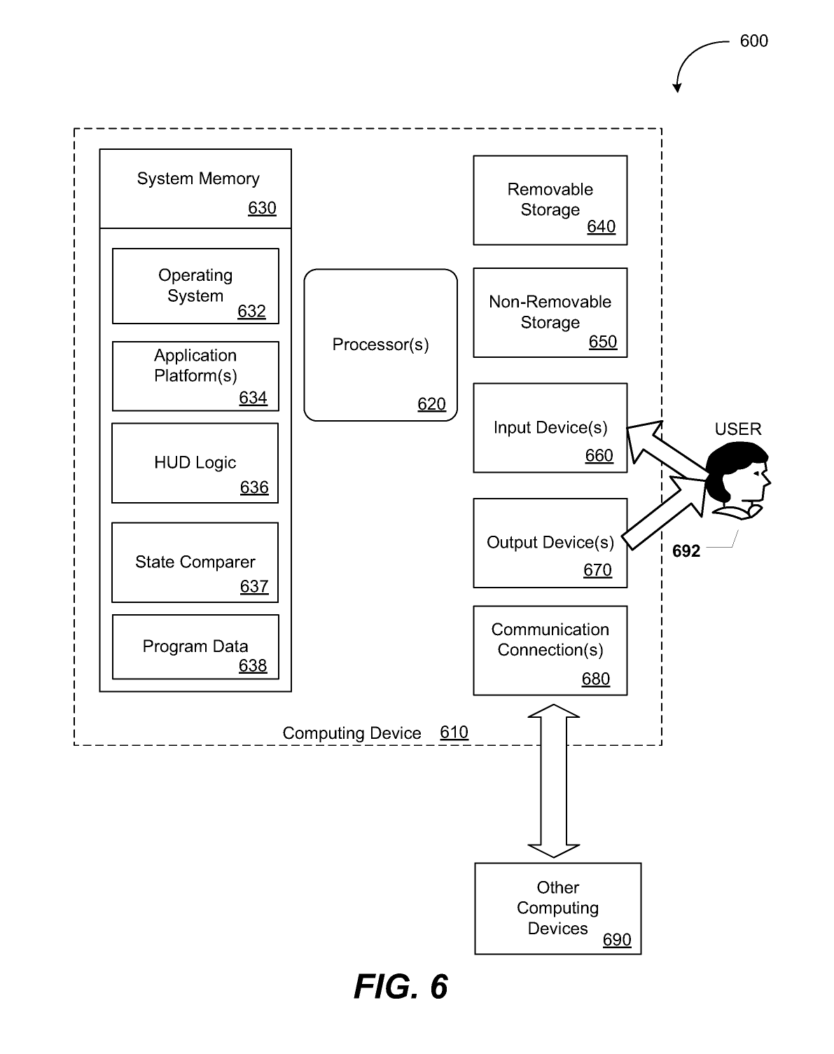

FIG. 6 depicts a block diagram of a computing environment 600 including a computing device 610 operable to support embodiments of computer-implemented methods, computer program products, and system components according to the present disclosure. In an illustrative embodiment, the computing device 610 may include one or more of the system 100 of FIG. 1 or components thereof, the system 200 of FIG. 2 or components thereof, and the tiers 310, 320, and 330 of FIG. 3. Each of the system 100 of FIG. 1 or components thereof, the system 200 of FIG. 2 or components thereof, and the tiers 310, 320, and 330 of FIG. 3 may include or be implemented using the computing device 610 or a portion thereof.

The computing device 610 includes at least one processor 620 and a system memory 630. Depending on the configuration and type of computing device, the system memory 630 may be volatile (such as random access memory or “RAM”), non-volatile (such as read-only memory or “ROM,” flash memory, and similar memory devices that maintain stored data even when power is not provided), or some combination of the two. The system memory 630 typically includes an operating system 632, one or more application platforms 634, one or more applications, and program data 638.

For example, the system memory 630 may include HUD logic 636 and a state comparer 637. In an illustrative embodiment, the HUD logic may generate and update the HUD 110 of FIG. 1 or the HUD 211 of FIG. 2. The HUD may be configured to display multiple execution environments, where one execution environment is designated as a driver execution environment. The HUD may also be configured to receive a UI action (e.g., associated with a UI test) at the driver execution environment and to transmit a representation of the UI action from the driver execution environment to each of the other execution environments. The UI action may be substantially concurrently repeated at each of the other execution environments. The state comparer may compare states of various execution environments.

The computing device 610 may also have additional features or functionality. For example, the computing device 610 may also include removable and/or non-removable additional data storage devices such as magnetic disks, optical disks, tape, and standard-sized or flash memory cards. Such additional storage is illustrated in FIG. 6 by removable storage 640 and non-removable storage 650. Computer storage media may include volatile and/or non-volatile storage and removable and/or non-removable media implemented in any technology for storage of information such as computer-readable instructions, data structures, program components or other data. The system memory 630, the removable storage 640 and the non-removable storage 650 are all examples of computer storage media. The computer storage media includes, but is not limited to, RAM, ROM, electrically erasable programmable read-only memory (EEPROM), flash memory or other memory technology, compact disks (CD), digital versatile disks (DVD) or other optical storage, magnetic cassettes, magnetic tape, magnetic disk storage or other magnetic storage devices, or any other medium that can be used to store information and that can be accessed by the computing device 610. Any such computer storage media may be part of the computing device 610.

The computing device 610 may also have input device(s) 660, such as a keyboard, mouse, pen, voice input device, touch input device, etc. Output device(s) 670, such as a display, speakers, printer, etc. may also be included. The input device(s) 660 and the output device(s) 670 may be operable to receive UI actions from and provide visual indicators to a user 692. The computing device 610 also contains one or more communication connections 680 that allow the computing device 610 to communicate with other computing devices 690 over a wired or a wireless network. The one or more communications connections 680 may also enable communications between various virtual machines at the computing device 610. In a particular embodiment, the one or more communication connections 680 include the communications bus 150 of FIG. 1 or the communications bus 240 of FIG. 2. The communications bus may be coupled to multiple execution environments and may broadcast data between the multiple execution environments.

It will be appreciated that not all of the components or devices illustrated in FIG. 6 or otherwise described in the previous paragraphs are necessary to support embodiments as herein described. For example, the removable storage 640 may be optional.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

Those of skill would further appreciate that the various illustrative logical blocks, configurations, modules, and process steps or instructions described in connection with the embodiments disclosed herein may be implemented as electronic hardware or computer software. Various illustrative components, blocks, configurations, modules, or steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method described in connection with the embodiments disclosed herein may be embodied directly in hardware, in a software module executed by a processor, or in a combination of the two. A software module may reside in computer readable media, such as random access memory (RAM), flash memory, read only memory (ROM), registers, a hard disk, a removable disk, a CD-ROM, or any other form of storage medium known in the art. An exemplary storage medium is coupled to a processor such that the processor can read information from, and write information to, the storage medium. In the alternative, the storage medium may be integral to the processor or the processor and the storage medium may reside as discrete components in a computing device or computer system.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments.

The Abstract of the Disclosure is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments.

The previous description of the embodiments is provided to enable a person skilled in the art to make or use the embodiments. Various modifications to these embodiments will be readily apparent to those skilled in the art, and the generic principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A computer-implemented method, comprising:
selecting one or more tests associated with a user interface (UI)-based application;
selecting a plurality of execution environments, wherein one of the plurality of execution environments is designated a driver execution environment;
displaying a driver UI corresponding to the driver execution environment;
receiving a UI action associated with the one or more tests at the driver UI; and
transmitting a representation of the UI action from the driver execution environment to each of the other execution environments, wherein the UI action is substantially concurrently repeated at each of the other execution environments.

2. The computer-implemented of claim 1, further comprising receiving a second UI action at the driver UI and transmitting a representation of the second UI action from the driver execution environment to each of the other execution environments.

3. The computer-implemented method of claim 1, wherein transmitting the representation of the UI action comprises translating the UI action into a set of input device controls and transmitting the set of input device controls.

4. The computer-implemented method of claim 3, wherein the set of input device controls includes keyboard entries, mouse movements, mouse clicks, pen controls, touchscreen controls, multi-touch controls, or any combination thereof.

5. The computer-implemented method of claim 3, wherein the set of input device controls is transmitted in a serialized format.

6. The computer-implemented method of claim 1, wherein transmitting the representation of the UI action comprises broadcasting the representation of the UI action via a communications bus that is coupled to each of the plurality of execution environments.

7. The computer-implemented method of claim 1, wherein the driver UI is displayed at a heads-up display (HUD) that is configured to display each of the plurality of execution environments.

8. The computer-implemented method of claim 7, further comprising receiving a user designation of a new driver execution environment at the HUD.

9. The computer-implemented method of claim 7, further comprising displaying a visual indicator at the HUD to indicate that a first execution environment has a first state that is different from a second state of a second execution environment.

10. The computer-implemented method of claim 9, wherein at least one of the first state or the second state comprises a UI screenshot, a navigational state, a modal state, an automation state, a parametric state, one or more performance metrics, or any combination thereof.

11. The computer-implemented method of claim 9, further comprising creating an entry at a log file to indicate the difference between the first state of the first execution environment and the second state of the second execution environment.

12. The computer-implemented method of claim 7, wherein the HUD displays at least one execution environment via a remote desktop protocol (RDP) session with the at least one execution environment.

13. A computer system, comprising:
a memory; and
a processor coupled to the memory, wherein the processor is configured to execute instructions that cause execution of a user interface (UI) testing application comprising:
a heads-up display (HUD) configured to:
display each of a plurality of execution environments, wherein one of the plurality of execution environments is designated as a driver execution environment;
receive a UI action associated with a UI test at the driver execution environment; and
transmit a representation of the UI action from the driver environment to each of the other execution environments, wherein the UI action is substantially concurrently repeated at each of the other execution environments; and
a communications bus coupled to each of the plurality of execution environments and configured to broadcast data from the driver execution environments to each of the other execution environments.

14. The computer system of claim 13, wherein the UI testing application further comprises a state comparer configured to compare a first state of a first execution environment with a second state of a second execution environment.

15. The computer system of claim 14, wherein the HUD is further configured to display a visual indicator when the state comparer detects a state mismatch between two execution environments.

16. The computer system of claim 13, wherein at least one of the plurality of execution environments further comprises a test recorder configured to store representations of a plurality of UI actions.

17. The computer system of claim 16, wherein at least one of the plurality of execution environments further comprises a test player configured to reproduce the plurality of UI actions.

18. A computer-readable medium comprising instructions, that when executed by a computer, cause the computer to:
select one or more tests associated with a user interface (UI)-based application;
select a plurality execution environments, wherein one of the plurality of execution environments is designated a driver execution environment;
initialize a communication agent at each of the plurality of execution environments;
display a driver UI corresponding to the driver execution environment;
receive a UI action associated with the one or more tests at the driver UI; and
transmit a representation of the UI action from the communication agent at the driver execution environment to the communication agent at each of the other execution environments via a communications bus, wherein the UI action is substantially concurrently repeated at each of the other execution environments.

19. The computer-readable medium of claim 18, wherein a first execution environment of the plurality of execution environments is executed at a different computing device than a second execution environment of the plurality of execution environments.

20. The computer-readable medium of claim 19, wherein the first execution environment and the second execution environment differ with respect to display resolution, text language, software application, operating system, hardware architecture, or any combination thereof.
